(19) United States
(12) Patent Application Publication
(10) Pub. No.: US 2008/0154705 A1
(43) Pub. Date: Jun. 26, 2008

(54) ADVERTISING RISK MITIGATION

(75) Inventors: Alexander Gounares, Kirkland, WA (US); Lili Cheng, Bellevue, WA (US); Nishant V. Dani, Redmond, WA (US); Gary W. Flake, Bellevue, WA (US); Eric J. Horvitz, Kirkland, WA (US); Kamal Jain, Bellevue, WA (US); Tarek Najm, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/960,110

(22) Filed: Dec. 19, 2007

Related U.S. Application Data
(60) Provisional application No. 60/870,926, filed on Dec. 20, 2006.

(51) Int. Cl. G06F 17/00; G06Q 30/00

(52) U.S. Cl. 705/10; 705/7; 705/14

(57) ABSTRACT

The claimed subject matter relates to an architecture that can facilitate use of beneficial advertising opportunities in order to mitigate risks to a seller in connection with advertising expenses. The architecture can receive from the seller, inter alia, an indication of profits allocated to a host in exchange for advertising an item on behalf of the seller. Based upon the received data as well as information obtained from other sources, the architecture can determine a value associated with advertising for the seller. By ranking the values, the architecture can efficiently allocate advertising resources to the sellers that provide the highest value, while at the same time effectively ensure that the seller has little or no risk associated with the costs of advertising.

### CROSS-REFERENCE TO RELATED APPLICATIONS

This application claims the benefit of U.S. Provisional Application Ser. No. 60/870,926, filed Dec. 20, 2006, entitled “ARCHITECTURES FOR SEARCH AND ADVERTISING.” The entirety of this application is incorporated herein by reference.

### BACKGROUND

Advertising is generally considered to be a capable means for producing revenue in most commercial markets or settings. Recently, the Internet and, specifically, Internet search engines have shown that they can provide a viable alternative to conventional advertising. Accordingly, advertisers are increasingly looking to search engines and search engine marketing (SEM) systems to advertise their products and services. As a result, Internet advertising has seen enormous growth over the past decade, yet, while the Internet has served to level the playing field between many types of competitors, Internet advertising in particular is still dominated by large and/or sophisticated participants to the exclusion of smaller, less savvy participants.

In conventional advertising spaces, small- to medium sized businesses (SMBs) are not well-situated to compete with larger entities. Not only do smaller businesses maintain smaller (or no) advertising budget, they typically do not have access to similar information as large businesses. For example, large entities can maintain vast data stores with proprietary information utilized with back-end systems that are tied to accounting systems to indicate, inter alia, the value of particular keywords, cost-per-1000 impressions (CPM), cost-per-click (CPC), cost-per-action (CPA), or advertising ROI. Thus, large entities can make informed decisions to increase revenue, market share and/or advertising effectiveness, whereas small businesses essentially have no way to compete.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one aspect thereof, comprises an architecture that can facilitate use of beneficial advertising opportunities in order to mitigate risks to a seller in connection with advertising costs. In addition, the architecture can facilitating and/or encourage web-based advertisement by small or unsophisticated entities regardless of an information gap in understanding web-based advertisement, a lack of statistical information, a lack of any means for collecting such information, and regardless of whether or not the entity maintains an advertising budget.

In accordance therewith and other related ends, the architecture (e.g., maintained by a host) can facilitate or sponsor advertisements on behalf of the entity (e.g., the seller), and can further do so adhering to economic principles that favor efficiency. In particular, the seller need not be required to direct, maintain, or pay for advertisements on its behalf. Rather, the seller can designate a profit allocation to be paid each time the host's advertising efforts lead to a sale of a good or service. Hence, the seller can be guaranteed an expected net profit and need only pay the host some amount of the transaction revenue that exceeds the expected net profit. In other words, the seller essentially keeps all revenue generated without the aid of the host, and pays only a portion of increased revenue that directly resulted from the host's efforts.

In more detail, based at least in part upon the profit allocation, the architecture can determine the respective values of one or more advertisements. For example, a first seller might allocate $1 to the host, while a second seller might allocate $2 to the host. All other things being equivalent, the higher profit allocation provided by the second seller will yield a higher advertisement value from the host's perspective, as advertising for the second seller will be more profitable for the host. However, a variety of other factors can be examined and employed to determine the advertisement value (to the host), so it will not always be the case that a high profit allocation results in a high ad value.

While the benefits to the seller are readily apparent, it should be appreciated that the host can also benefit by efficiently allocating advertisements that represent high advertisement value to suitable ad space. In accordance therewith, the architecture can transmit relevant information to a search engine marketing (SEM) system. The SEM system can be associated with a search engine system, where the actual ad space for the advertisement can exist. In accordance with various aspects of the claimed subject matter, the architecture described herein can exist as a component of the SEM or on a computer-readable medium (e.g., as or in connection with a financial application, package, or suite) that can be installed on a computer.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a block diagram of a system that can facilitate use of beneficial advertising opportunities in order to mitigate risks to a seller in connection with advertising costs.

FIG. 2 illustrates a block diagram of various examples of information or data types included in updated data 120.

FIG. 3 depicts a block diagram of a system that can examine suitable markets and/or suitable ad space to determine advertisement value 116.

FIG. 4 illustrates a block diagram of a system that can facilitate creation of suitable advertisements 210 and/or payments for advertising thereof.

FIG. 5A is a block diagram of topology 500 in which system 100 is included in SEM system 124.

FIG. 5B is a block diagram of topology 502 in which system 100 can be stored on computer-readable medium 504.

FIG. 6 depicts a block diagram of a system that can aid with various inferences.

FIG. 7 is an exemplary flow chart of procedures that define a method for facilitating use of beneficial advertising opportunities for mitigating risks to a seller in connection with advertising costs.

FIG. 8 depicts an exemplary flow chart of procedures that define a method for determining the advertisement value in accordance with a variety of data sets and/or utilizing the advertisement value for the purpose of ranking.

FIG. 9 illustrates an exemplary flow chart of procedures that define a method for mitigating risks to a seller in connection with advertising costs by subsuming the role of advertising for the seller.

FIG. 10 depicts an exemplary flow chart of procedures defining a method for providing additional features in connection with mitigating advertising risks to a seller.

FIG. 11 illustrates a block diagram of a computer operable to execute the disclosed architecture.

FIG. 12 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system,” or the like can, but need not, refer to a computer-related entity, either hardware, a combination of hardware and software, software, or software in execution. For example, a component might be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “infer” or “inference” generally refer to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

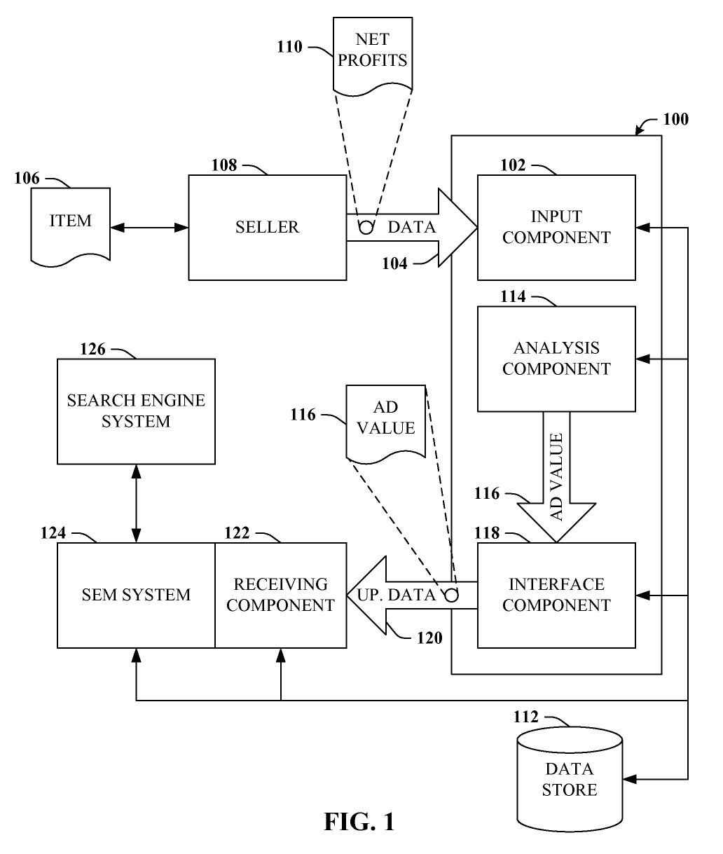

Referring now to the drawings, with reference initially to FIG. 1, system 100 that can facilitate use of beneficial advertising opportunities in order to mitigate risks to a seller in connection with advertising costs is depicted. Generally, system 100 can include input component 102 that can receive data 104 that relates to item 106 for sale by seller 108. Typically, item 106 can be substantially any product or service, commonly a product or service that can benefit from web-based advertising. Thus, item 106 can be a new, retail, or wholesale item common in business-to-consumer (B2C) domains, yet in some cases item 106 can instead be a used or pre-owned product. Oftentimes, seller 108 will be a small- to medium-sized business (SMB) who conventionally does not have access to the same statistics and empirical data as larger businesses. However, it should be appreciated that seller 108 can be substantially any business, vendor, entity, or even an individual. It should be appreciated that examples of both item 106 and seller 108 provided herein are not necessarily intended to limit the appended claims, as other examples can exist, yet, in some cases either item 106 or seller 108 can be restricted to a particular class or domain.

One object that can be facilitated by the claimed subject matter is to level the advertising playing field between large businesses with sophisticated back-end and accounting systems with large amounts of data pertaining to web advertising and/or the values of particular keywords, etc. relative to small, inexperienced, or unsophisticated businesses who do not have the data necessary to be competitive. As such, the claimed subject matter can encourage advertising from those who might otherwise not do so and, therefore, miss out on the associated benefits or opportunities simply because of a lack of useful data or market savvy. Moreover, the above can be accomplished at virtually no risk to small business advertisers because rather than paying for an advertisement or an ad campaign up front, the ads can be managed by a sophisticated third party (e.g., host) who utilizes the claimed subject matter, and who can be paid only for increases in sales of the client (e.g., seller 108). Thus, the client need not be charged with the costs, knowledge, or responsibilities associated with advertising and need only pay for actual results (e.g. increased sales due to advertising funded by another party). Furthermore, since the host (e.g., a search engine marketing (SEM) system and/or an associated search engine system) might be paid only a percentage of increased sales, the host is also economically motivated to increase the sales of the client as much as possible, creating a win-win situation.

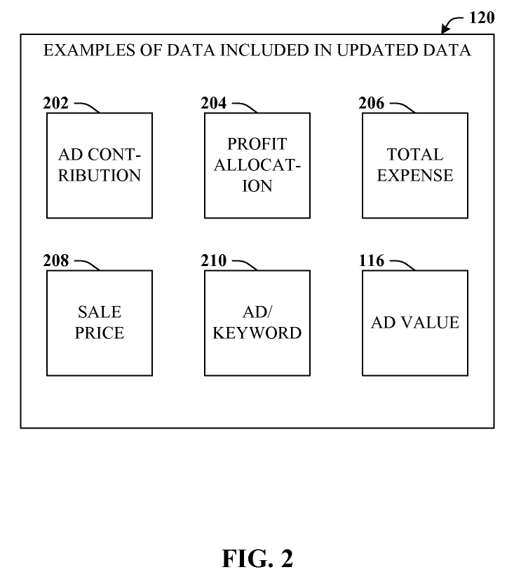

Continuing the examination of FIG. 1, data 104 received by input component 102 can include a wide array of information relating to item 106, many examples of which are further detailed in connection with FIG. 2. Data 104 can also include an indication of expected net profits 110 in connection with a sale of item 106. The indication of expected net profits 110 can be provided in a variety of ways, but it should be understood that the expected net profits 110 is intended to represent a quantifiable profit to seller 108 expected upon sale/conversion of item 106. Generally, this is simplified in accounting terms as income (e.g., amount tendered by a customer) minus expenses (e.g., costs to seller 108). As another example, the indication of expected net profits 110 can also be a sale price minus expenses less a profit allocation, where the profit allocation can be an amount that is allocated to the host in exchange for advertising item 106. The profit allocation can be, e.g., a margin (or percent) on expenses, a margin on the sale price, or even an absolute monetary value. For example, seller 108 can denote the profit allocation as, say, 10% of a product that costs $10 to produce and make available for sale, 10% of a product that sells for $10, or simply indicate that seller 108 is willing to provide $1 to the host per sale generated by the host's advertising of item 106.

It should be understood that data 104, as well as other information described herein or otherwise suitable can be saved to data store 112 for later access or recall. Data store 112 is intended to be a repository of all or portions of data, data sets, or information described herein or otherwise suitable. Data store 112 can be centralized or distributed, potentially across multiple devices and/or schemas.

In addition, it should be appreciated that the indication of expected net profits 110 as well as other parameters described herein (e.g., profit allocation) can be tiered based upon conversion volume during a period. For instance, seller 108 might be willing to accept a smaller net profit 110 per item 106 sold if a large number of items 106 are sold during, say, a business cycle, fiscal quarter, etc. Hence, volume pricing can be available and utilized by the claimed subject matter and provided in data 104. However, unlike conventional volume pricing, rather than passing on all of the costs savings from a higher economy of scale to end consumers, all or portions of these savings can be allocated to the host, thereby providing an incentive to the host to meet certain thresholds for the number of sales generated by way of advertising. Thus, it is readily apparent that the host can benefit in a manner similar to conventional benefits of volume or aggregate pricing tiers.

System 100 can also include analysis component 114 that can examine data 104 to determine advertisement value 116. Advertisement value 116 can be a value represented to the host that is intrinsic to advertising item 106 for seller 108. In addition, analysis component 114 can update data 104 to created updated data 120 by, e.g. adding to data 104 (or portions thereof) advertisement value 116. Generally, advertisement value 116 is based upon a profit to the host that can be derived from the sale of item 106 that exceeds net profit 110 expected by seller 108. In other words, seller 108 can indicate either directly or indirectly how much will be paid to the host for each conversion facilitated by the host's advertising efforts on behalf of seller 108.

By way of illustration, seller 108 can indicated that the cost to produce or ultimately convert item 106 is, say, $10 dollars, and seller 108 expects to make a minimum of $1 dollar or 10% for every item 106. If the host can facilitate a conversion of item 106 at a price above $11, the host stands to gain any excess above that amount. For instance if item 106 is sold for $12, then the host can gain $1 (e.g., profit allocation) for every conversion of item 106 facilitated by the host. Naturally, the greater the profit allocation to the host, the greater the host's incentive will be to advertise item 106 for seller 108, and meanwhile seller 108 need not be concerned by misallocation of an ad budget since the profit allocation typically only applies to transactions that were brought about by the host's activities and, moreover, guarantees seller 108 the expected net profit 110 for the transaction.

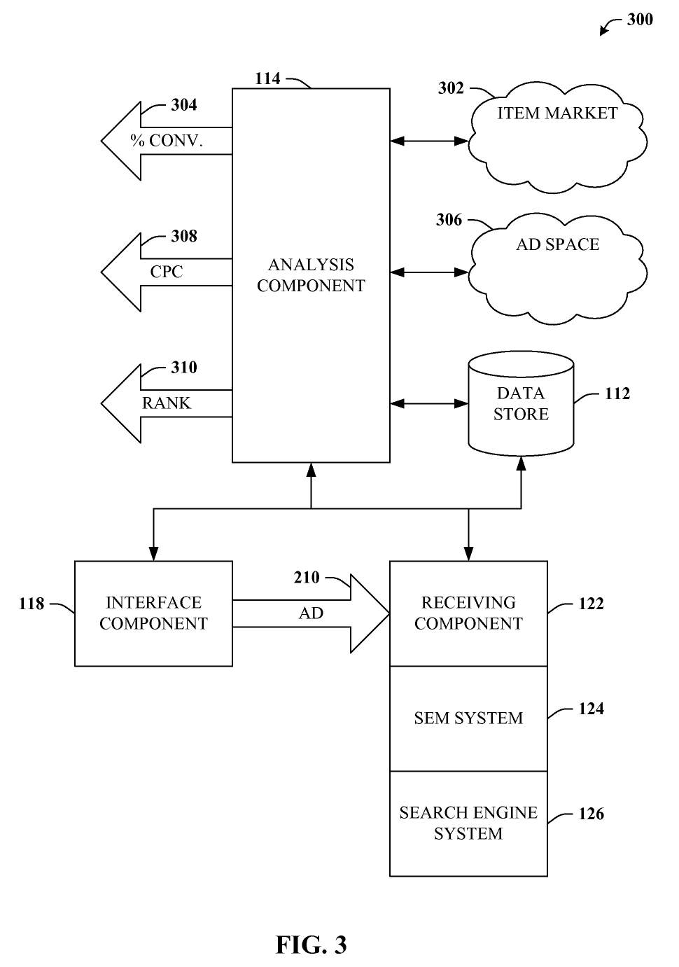

It should be appreciated that in the example above, while the profit allocation is $1, this value is not necessarily advertisement value 116. In particular, advertisement value 116 is generally intended to represent a value to the host for advertising for the seller, which can include an analysis of not only what the profit allocation is, but also advertising costs, opportunity costs (e.g., potential profits from other sellers 108), price points, price elasticity, consumer demand, seller branding, seller reputation, and so on and so forth. In short, while the profit allocation from a first seller can be, say, $2 and from a second seller only $1, the second seller can have a higher advertisement value 116 due to a variety of factors such as a determination (e.g. by analysis component 114 or by the host) that ads for the second seller will be more than twice as effective as those for the first seller. Hence, efforts directed to the second seller can be more lucrative to the host even though the host is allocated a smaller dollar amount per transaction, which is further detailed in connection with FIG. 3.

In addition, system 100 can also include interface component 118 that can be communicatively coupled to receiving component 122 of SEM system 124, wherein SEM system 124 can be associated with search engine system 126 that is network-accessible such as by way of the Internet or the like. The SEM system 124 can be designed specifically for features or aspects described herein or can be a conventional SEM system 124 that can include search engine optimization (SEO), paid placement, paid inclusions, as well as mechanisms for promoting visibility of webpages, advertisements, and/or search terms or keywords.

In essence, interface component 118 can provide a gateway for communicating with or interfacing to SEM system 124 or components thereof, by way of receiving component 122. In particular, interface component 118 can transmit at least a portion of updated data 120 to receiving component 122, wherein updated data 120 can include all or portions of data 104, other information provided by analysis component 114 such as advertisement value 116, as well as other suitable information, examples of which are provided in connection with FIG. 2. Moreover, it should be appreciated that any data described herein can be stored to data store 112, which is also further detailed with respect to FIG. 3, infra.

Turning now to FIG. 2, various examples of information or data types included in updated data 120 are provided. In general, the examples provided herein are intended to represent concrete illustrations of the kind of information that can be included in data 104 or added thereto to create updated data 120, which can be transmitted to receiving component 122. In particular, updated data 120 can include ad contribution 202. Ad contribution 202 can be included in data 104 and can be, e.g. an indication of an amount seller 108 is willing to contribute up-front. For example, in addition to what has been described above, while not strictly necessary, seller 108 can contribute an initial amount of financing to the advertisement of item 106. In such a case, the host can employ the financing indicated by ad contribution 202 to sponsor initial advertising endeavors, which can be monitored to make or refine determinations related to advertisement value 116.

Another type of information that can be included in updated data 120 can be profit allocation 204, which, as described supra, can be an indication of an amount or percentage allocated to the host upon conversion of item 106 in exchange for the host's activities in advertising item 106. Typically, profit allocation 204 will be included in data 104 received by input component 102. Updated data 120 can also include an indication of total expense 206 associated with item 106, such as production, shipping, storage, or maintenance costs and so on. As with the previous examples, total expense 206 will generally be provided by seller 108 and included in data 104.

Similarly, updated data 120 can include sale price 208, which can be provided by seller 108 or determined or modified by analysis component 114 (see FIG. 3 and associated description). For instance, seller 108 might typically sell item 106 for $15, and as such include this information in data 104. However, analysis component 114 may determine that $15 is not the optimal price for item 106, and therefore modify sale price 208 accordingly. While it is readily apparent that sale price 208, when modified, can be raised, it should also be understood that lowering sale price 208 can also be a viable strategy for the host. For example, suppose seller 108 includes in data 104 total expenses 206 associated with item 106 are $10, seller 108 expects $3 profit (e.g., expected net profit 110), and provides sale price 208 of $15, tacitly indicating that profit allocation 204 is $2 (e.g., $15−$13=$2). In such a case, analysis component 114 can determine that sale price 208 of, say $14 will optimize advertisement value 116, for instance when competition price points are higher. Appreciably, this lower sale price 208 will typically lower the host's margin per conversion (but not expected net profits 110 of seller 108 per conversion), but can be more lucrative in the end due to higher sales volumes and/or increasing the effectiveness of the advertising given, for example, a lower advertised price.

As with sale price 208, seller 108 can provide an advertisement 210 (or keyword 210) to input component 102, however, this will generally not be the case, as analysis component 114 (and/or the host) will generally be better equipped to optimize the advertising of item 106. Also included in updated data 120 can be advertisement value 116, which can be a representation of the value to the host for advertising for seller 108 as substantially described supra.

With reference now to FIG. 3, system 300 that can examine suitable markets and/or suitable ad space to determine advertisement value 116 is illustrated. In general, system 300 can include analysis component 114 that can examine data 104 in order to determine advertisement value 116. In addition to that described supra, analysis component 114 can further examine marketplace 302 to determine advertisement value 116, wherein marketplace 302 can relate to item 106. For example, analysis component 114 can examine market trends for item 106, aspects of supply and demand, competition, pricing structures, quality, rankings, or substantially any facet of marketplace 302 that can relate to sale or advertisement of item 106. As one specific example, analysis component 114 can examine marketplace 302 to determine or infer a probability of conversion 304 for item 106. For instance, the probability of conversion 304 can relate to the likelihood of advertisement 210 resulting in a conversion of item 106. Generally, a higher probability of conversion 304 will equate to a higher advertisement value 116, all other factors being equal.

In another aspect of the claimed subject matter, analysis component 114 can examine ad space 306 for advertisement 210 (or to associate with keyword 210) for item 106 in order to determine cost-per-conversion (CPC) 308. Suitable ad space 306 can relate to web-based advertisements such as banner ads as well as ads or sponsored ads in connection with search results, e.g., provided by search engine system 126. CPC 308 can relate to the total expenditures necessary (e.g., on average) to yield a sale of item 106. Appreciably, as introduced above, analysis component 114 can examine not only the costs associated with suitable ad space 306, but also opportunity costs associated with selecting one advertisement 210 over another (e.g., an advertisement for a different item and/or from a different seller).

According to another aspect of the claimed subject matter, analysis component 114 can provide rank 310 of advertisement 210 based upon advertisement value 116. Typically, the higher or better advertisement value 116, the higher or better will be rank 310. In addition, analysis component can select advertisement 210 from a set of advertisements based upon rank 310, where the set of advertisements can be acquired from data store 112 or received by another suitable means. Typically, analysis component 114 will select advertisement 210 with the highest rank 310, as the highest ranked advertisement 210 will normally represent optimal advertisement value 116 to the host.

In accordance therewith, the selected advertisement 210 can be delivered to interface component 118, which can, in turn, transmit advertisement 210 to receiving component 122. Hence, SEM system 124 can be in possession of advertisement 210 as well as other relevant information (e.g., updated data 120) necessary to advertise item 106, commonly utilizing an associated search engine system 126 to provide ad space 306 for advertisement 210. As with other information described herein, any data received or determined or inferred can be stored to data store 112.

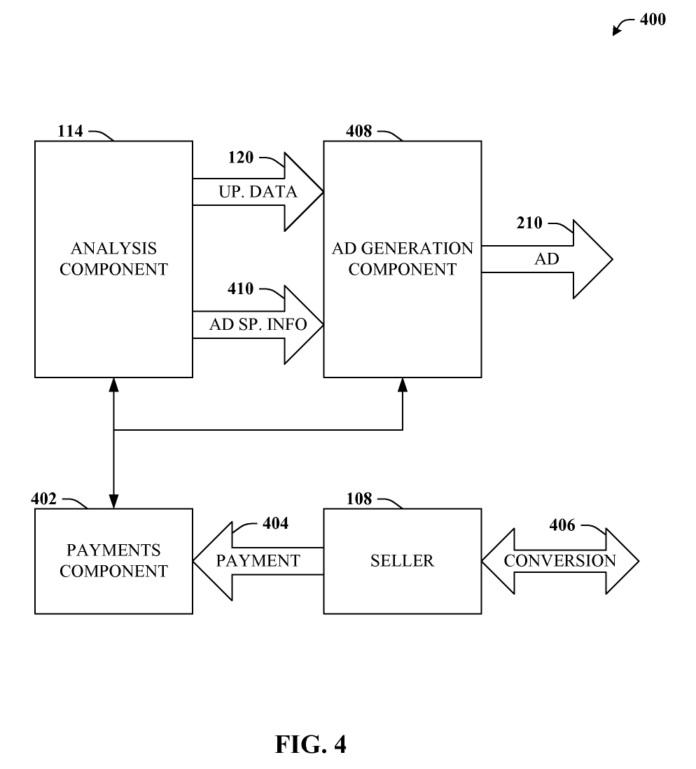

Referring to FIG. 4, system 400 that can facilitate creation of suitable advertisements 210 and/or payments for advertising thereof is depicted. Typically, system 400 can include payments component 402 that can receive payment 404 from seller 108 after conversion 406 of item 106. More particularly, transactions (e.g. purchases) relating to item 106 that were facilitated by the host (e.g., by way of advertisement 210 or sponsorship thereof), can represent increased profits to seller 108, for which seller 108 can allocate a portion of the increased profits back to the host. Accordingly, payment 404 can be equivalent to profit allocation 204 agreed upon by seller 108, or an amount that exceeds the aggregate of expenses 206 plus expected net profits 110.

Additionally, system 400 can include ad generation component 408 that can automatically or dynamically create advertisement 210 based upon updated data 120. Furthermore, ad generation component 408 can create advertisement 210 based upon information associated with suitable ad space 410. As depicted, ad generation component 408 can receive both updated data 120 and information 410 relating to suitable ad space directly from analysis component 114 or from another source such as data store 112. Appreciably, given the rich reserves of data available to ad generation component 408 and a potentially superior understanding of market and advertising dynamics generally associated with SEM systems and SEO systems, which can also be available, ad generation component 408 can provide additional benefit to seller 108. Accordingly, rather than supplying advertisement 210 or choosing particular keywords 210, seller 108 can delegate this task in whole or in part to ad generation component 408. Ad generation component 408 can examine historical trends, identify and assess elements of successful marketing, employ data relating to competitors of seller 108, or even receive input from a human actor such as a marketing agent in order to create or identify ad/keyword 210.

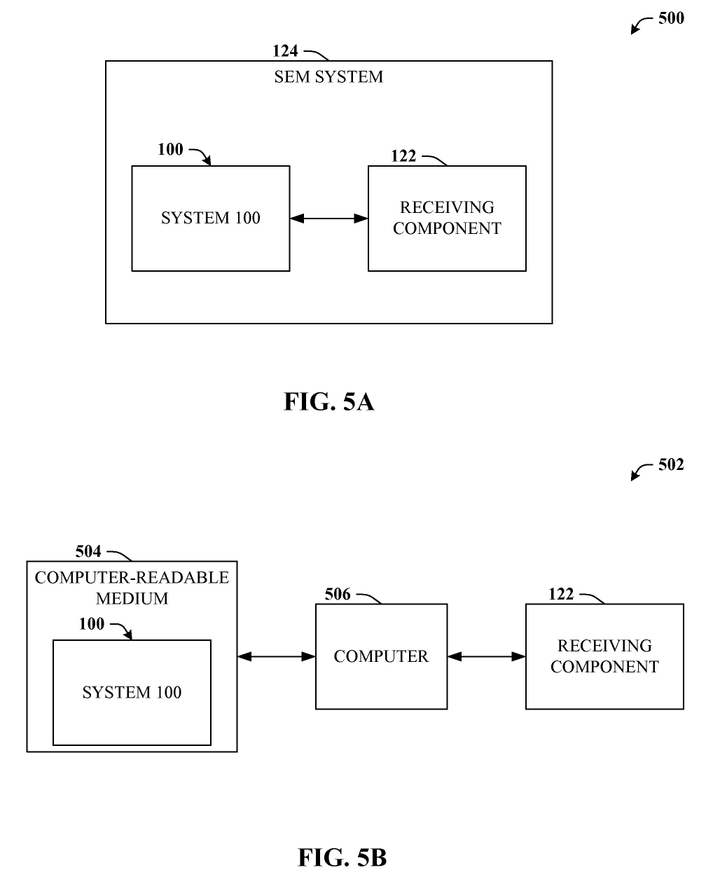

FIGS. 5A and 5B illustrate example operating topologies and/or environments that can be utilized to implement the claimed subject matter. Briefly, FIG. 5A depicts topology 500 in which system 100 is included in SEM system 124. Appreciably, all or portions of system 100 as well as other components described herein can be components of SEM system 124, as can receiving component 122. Accordingly, SEM system 124 can manage many or all of the features described herein by direct interaction with system 100 or components thereof or described herein.

FIG. 5B illustrates topology 502 in which system 100 can be stored on computer-readable medium 504. In particular, all or portions of system 100 as well as other components detailed herein can be included in computer-readable medium 504. For example, system 100 can be or can be included with a software application or suite that can be installed on computer 506, e.g., a computer maintained or utilized by seller 108. Seller 108 can input data 104 to the installed application or package, and updated data 120 can be transmitted to receiving component 122 by way of a network such as the Internet.

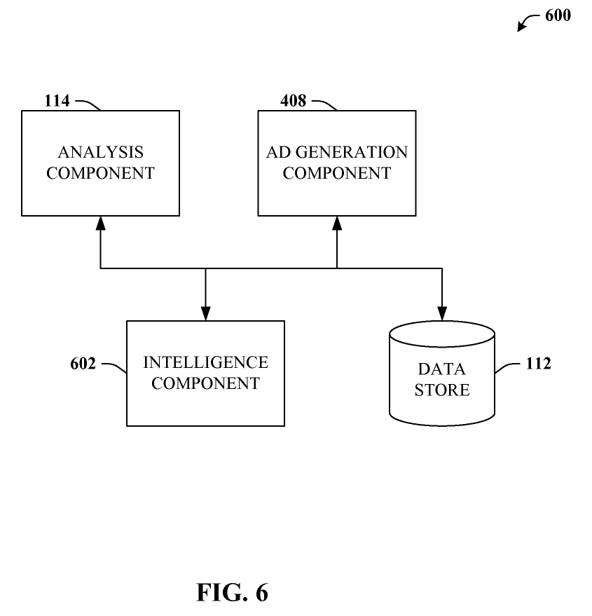

With reference now to FIG. 6, system 600 that can aid with various determinations or inferences is depicted. Typically, system 600 can include analysis component 114 and/or ad generation component 408, which in addition to or in connection with what has been described supra, can also make various inferences or intelligent determinations. For example, analysis component 114 can employ machine learning techniques or inferences to intelligently determine a number of factors that can be employed to compose advertisement value 116. Such can be used in connection with examining marketplace 302, ad space 306 or other domains or data sets to identify or quantify probabilistic consequences of advertisement 210. Likewise, ad generation component 408 can also employ machine learning techniques or inferences to intelligently construct a suitable advertisement or optimize relationships involving suitable search term keywords in connection with item 106.

In addition, system 600 can also include intelligence component 602 that can provide for or aid in various inferences or determinations. It is to be appreciated that intelligence component 602 can be operatively coupled to all or some of the aforementioned components. Additionally or alternatively, all or portions of intelligence component 602 can be included in one or more of the components 114, 408. Moreover, intelligence component 602 will typically have access to all or portions of data sets described herein, such as data store 112, and can furthermore utilize previously determined or inferred data.

Accordingly, in order to provide for or aid in the numerous inferences described herein, intelligence component 602 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, where the hypersurface attempts to split the triggering criteria from the non-triggering events. Intuitively, this makes the classification correct for testing data that is near, but not identical to training data. Other directed and undirected model classification approaches include, e.g. naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

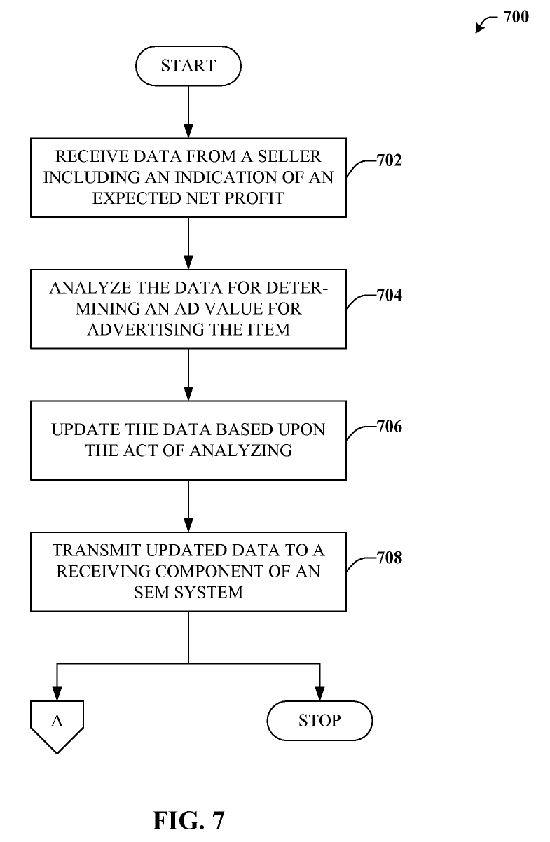

FIGS. 7, 8, and 9 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

With reference now to FIG. 7, exemplary method 700 for facilitating use of beneficial advertising opportunities for mitigating risks to a seller in connection with advertising costs is illustrated. Generally, at reference numeral 702, data that relates to an item for sale by a seller can be received. Typically, the data will include an indication of an expected net profit (for the seller) in connection with a sale of the item. In addition, the data can include a variety of other information such as, e.g. an indication of an advertising contribution from the seller, an advertisement or keyword, an indication of a profit allocation, an indication of a sale price, an indication of a total expense associated with the item, and so on. It should be appreciated that the indication of expected net profits can be a sale price minus expenses, a sale price minus expenses less the profit allocation, a margin on expenses, a margin on the sale price or a strict monetary value rather than a percentage, as well as any other suitable representation. Moreover, the expected net profits can be tiered based upon conversion volume during a particular period.

At reference numeral 704, the data received at act 702 can be analyzed for determining an advertisement value represented by advertising the item on behalf of the seller. Generally, the value is determined in terms of the value to a host, who can negotiate with the seller. Such a value can be based upon a profit from a transaction involving the item that exceeds the net profit expected by the seller.

At reference numeral 706, the data received at act 702 can be updated based upon the act of analyzing detailed in connection with act 704. In particular, updated data can be generated from the data by appending the advertisement value determined at act 704. Appreciably, updated data can include all or portions of the data received from the seller as well as that which is appended such as the advertisement value and other relevant data described herein. At reference numeral 708, the updated data can be transmitted to a receiving component of an SEM system that is associated with a network-accessible search engine system. In accordance therewith, the item can be advertised for the seller by way of the SEM, potentially populating ad space available on the search engine system.

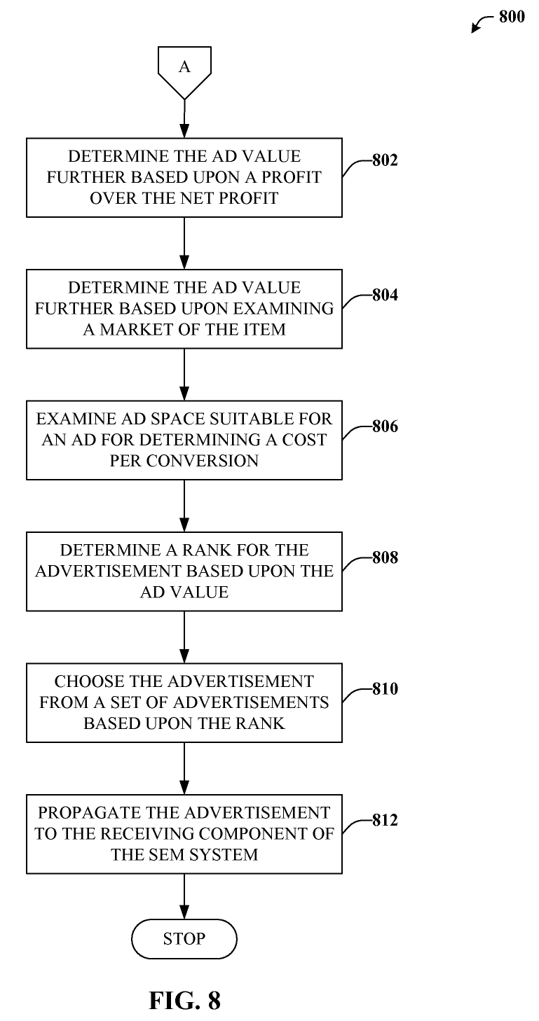

Referring to FIG. 8, exemplary method 800 for determining the advertisement value in accordance with a variety of data sets and/or utilizing the advertisement value for the purpose of ranking is depicted. For example, at reference numeral 802, the advertisement value can be further determined based upon a profit from the sale of the item that exceeds the net profits expected by the seller. In some cases, this amount will be known such as when the sale price is set, while in other cases, it should be appreciated that their may be some price elasticity and/or discretion on the part of the host as to the sale price.

Continuing on to reference numeral 804, the advertisement value can be further determined based upon examining a marketplace associated with the item. For example, market trends for the item, aspects of supply and demand, competition, pricing structures, quality, rankings, or substantially any facet of the marketplace that can relate to sale or advertisement of the item can be examined to aid in the determination of the advertisement value.

At reference numeral 806, ad space for an advertisement can be examined for determining a cost per conversion in connection with advertising the item. Suitable ad space can relate to web-based advertisements such as banner ads as well as ads or sponsored ads in connection with search results, e.g., provided by the search engine system. The cost per conversion can relate to the total advertising expenditures necessary (e.g., usually averaged) to yield a sale of the item.

Moving to reference numeral 808, a rank for the advertisement can be determined based upon the advertisement value. In accordance therewith, the advertisement that is most likely to generate optimal profits for the host will generally be most highly ranked. Hence, at reference numeral 810, the advertisement can be selected from a set of advertisements based upon the rank. Generally, the highest ranking advertisement will be selected. Thus, at reference numeral 812, the advertisement can be propagated to the receiving component of the SEM system for later display to a potential customer of the item.

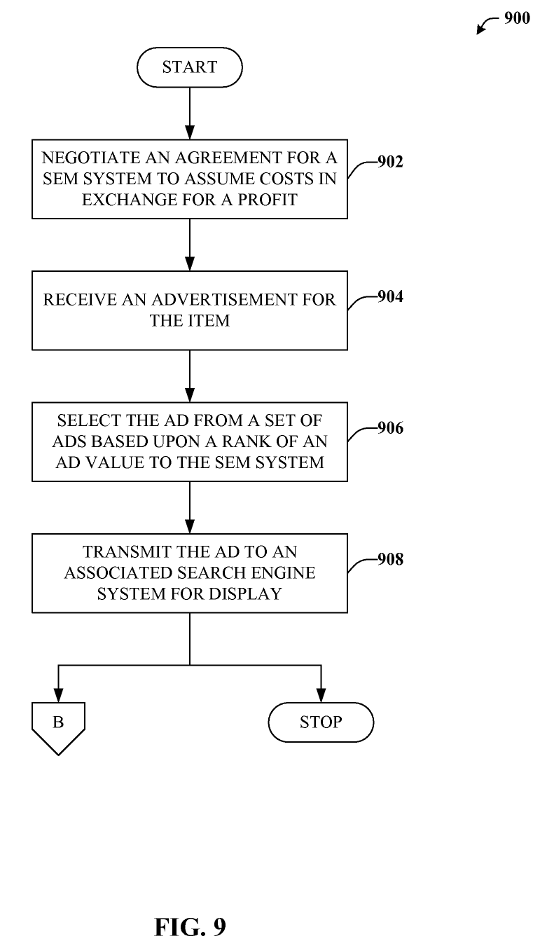

With reference now to FIG. 9, method 900 for mitigating risks to a seller in connection with advertising costs by subsuming the role of advertising for the seller is illustrated. Generally, at reference numeral 902, an agreement for a SEM system to assume all costs associated with advertising an item for a seller of the item can be negotiated in exchange for a profit allocation to be paid by the seller to the SEM system after conversion of the item. Hence, when the item is sold, the seller pays an agreed upon profit allocation to the SEM who advertised the item and facilitated the sale. The profit allocation can be, e.g. a margin (or percent) on expenses, a margin on the sale price, or even an absolute monetary value.

Continuing to reference numeral 904, an advertisement for the item can be received. For example, the advertisement related to the item can be acquired by the SEM. In some cases the received advertisement can be stored to a data store. Regardless, at reference numeral 906 the advertisement can be selected from a set of advertisements, typically from amongst those stored. Usually, the advertisement is selected based upon a rank of an advertisement value, wherein the advertisement value is generally a value to the SEM system. It is readily apparent that the value to the SEM system (e.g., advertisement value) can be determined based upon the profit allocation detailed at act 902. At reference numeral 908, the advertisement can be transmitted to an associated search engine system for display.

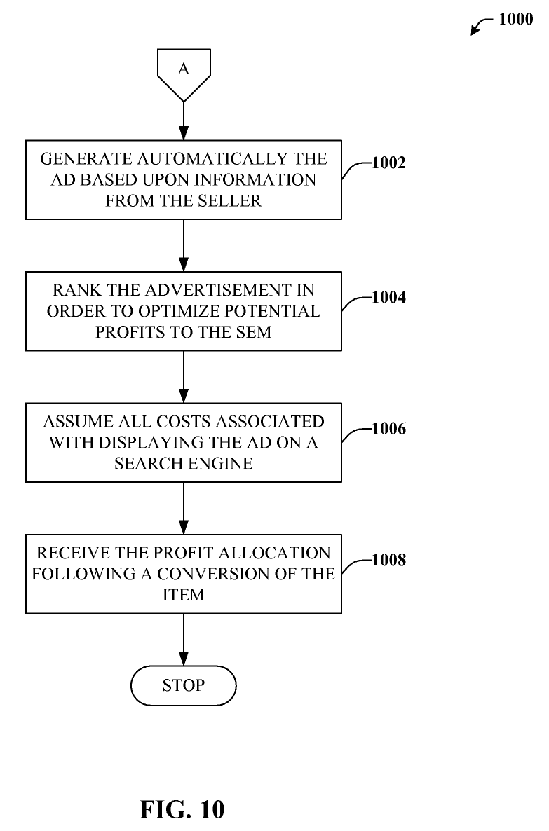

Turning now to FIG. 10, method 1000 for providing additional features in connection with mitigating advertising risks to a seller is depicted. At reference numeral 1002, the advertisement received at act 904 can be generated automatically based upon information received from the seller. For example, the information received from the seller can include data relating to the item, a price, an incentive or discount, and so on. Such information along with other data, potentially obtained by examining a marketplace or competing items, vendors, or advertisements can be employed to automatically create a web-based advertisement or key term.

Moving to reference numeral 1004, the advertisement can be ranked in order to optimize potential profits to the SEM based upon the profit allocation. In particular, said ranking can be utilized at act 906 in order to select the advertisement from the set of advertisements. Appreciably, however, the ranking need not be based solely upon the profit allocation, but can include other relevant variables or weightings such as a likelihood of conversion, cost per conversion, supply/demand indicators, external events (e.g., holidays, weekends . . . ) and so forth.

At reference numeral 1006, all costs associated with displaying the advertisement on the search engine system can be assumed by the SEM. Essentially, the advertising costs associated with the item can be subsumed by the SEM rather than billing the seller for the ad space, as is conventionally done. Next, at reference numeral 1008, the profit allocation can be received following a conversion of the item. As such, the present act represents receipt of payment by the SEM from the seller to for a percentage of profits generated by the advertising conducted by the SEM on the seller's behalf.

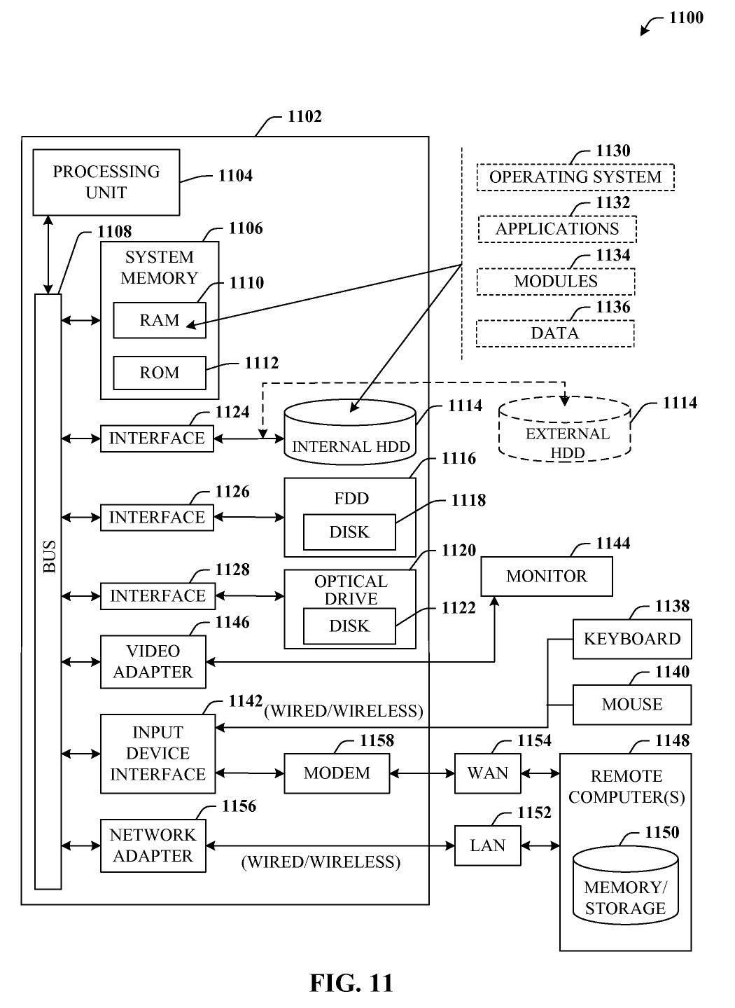

Referring now to FIG. 11, there is illustrated a block diagram of an exemplary computer system operable to execute the disclosed architecture. In order to provide additional context for various aspects of the claimed subject matter, FIG. 11 and the following discussion are intended to provide a brief, general description of a suitable computing environment 1100 in which the various aspects of the claimed subject matter can be implemented. Additionally, while the claimed subject matter described above may be suitable for application in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 11, the exemplary environment 1100 for implementing various aspects of the claimed subject matter includes a computer 1102, the computer 1102 including a processing unit 1104, a system memory 1106 and a system bus 1108. The system bus 1108 couples to system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is appreciated that the claimed subject matter can be implemented with various commercially available operating systems or combinations of operating systems.

A user can enter commands and information into the computer 1102 through one or more wired/wireless input devices, e.g. a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE1394 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g. a wide area network (WAN) 1154. Such LAN and WAN networking environments are commonplace in offices and companies, and facilitate enterprise-wide computer networks, such as intranets, all of which may connect to a global communications network, e.g. the Internet.

When used in a LAN networking environment, the computer 1102 is connected to the local network 1152 through a wired and/or wireless communication network interface or adapter 1156. The adapter 1156 may facilitate wired or wireless communication to the LAN 1152, which may also include a wireless access point disposed thereon for communicating with the wireless adapter 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11b) or 54 Mbps (802.11a) data rate, for example, or with products that contain both bands (dual band), so the networks can provide real-world performance similar to the basic “10BaseT” wired Ethernet networks used in many offices.

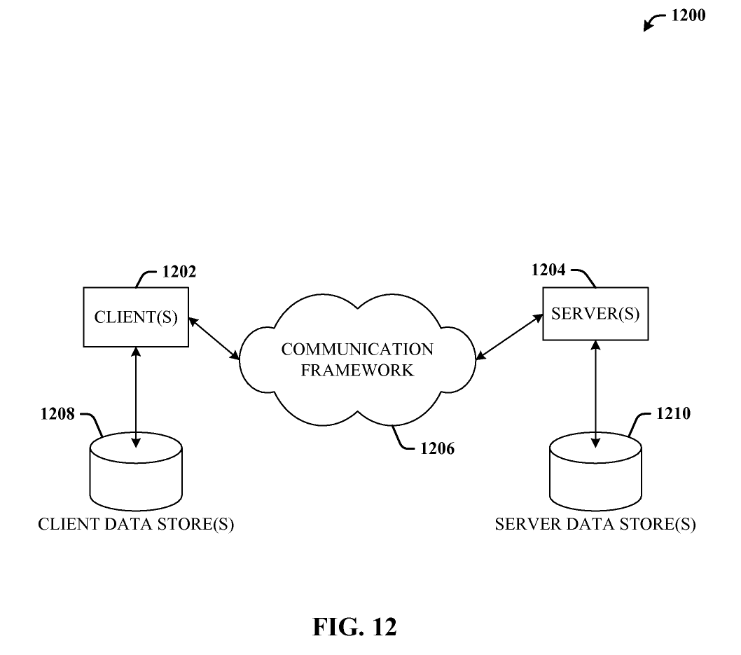

Referring now to FIG. 12, there is illustrated a schematic block diagram of an exemplary computer compilation system operable to execute the disclosed architecture. The system 1200 includes one or more client(s) 1202. The client(s) 1202 can be hardware and/or software (e.g., threads, processes, computing devices). The client(s) 1202 can house cookie(s) and/or associated contextual information by employing the claimed subject matter, for example.

The system 1200 also includes one or more server(s) 1204. The server(s) 1204 can also be hardware and/or software (e.g., threads, processes, computing devices). The servers 1204 can house threads to perform transformations by employing the claimed subject matter, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates use of beneficial advertising opportunities in order to mitigate risks to a seller in connection with advertising costs, comprising:
an input component that receives data that relates to an item for sale by a seller, the data includes an indication of an expected net profit in connection with a sale of the item;
an analysis component that examines the data to determine an advertisement value represented by advertising the item for the seller and that updates the data with the advertisement value; and
an interface component that is communicatively coupled to a receiving component of a search engine marketing (SEM) system associated with a network-accessible search engine system, the interface transmits at least a portion of the updated data to the receiving component.

2. The system of claim 1, the indication of expected net profits is at least one of a sale price minus expenses, a sale price minus expenses less a profit allocation, a margin on expenses, a margin on the sale price, or an absolute monetary value.

3. The system of claim 1, the indication of expected net profits is tiered based upon conversion volume during a period.

4. The system of claim 1, the advertisement value is based upon a profit from the sale that exceeds the net profit expected by the seller.

5. The system of claim 1, the updated data further includes at least one of an indication of an advertising contribution from the seller, an advertisement, a keyword, a profit allocation, a sale price, a total expense associated with the item, or the advertisement value.

6. The system of claim 1, the analysis component further examines a marketplace associated with the item to determine the advertisement value.

7. The system of claim 6, the analysis component examines the marketplace to determine a probability of conversion for the item.

8. The system of claim 7, the analysis component examines ad space suitable for an advertisement for the item to determine a cost per conversion.

9. The system of claim 8, the analysis component provides a rank of the advertisement based upon the advertisement value.

10. The system of claim 9, the analysis component selects the advertisement from a set of advertisements based upon the rank.

11. The system of claim 10, the interface component transmits the advertisement to the receiving component of the SEM system.

12. The system of claim 1, further comprising a payments component that receives a payment from the seller after conversion of the item, the payment is equal to a profit allocation agreed upon by the seller.

13. The system of claim 1, further comprising an ad generation component that automatically creates an advertisement based upon the updated data.

14. The system of claim 13, the ad generation component creates the advertisement further based upon suitable ad space.

15. The system of claim 1 is included in the SEM system.

16. The system of claim 1 is stored on a computer-readable medium.

17. A method for facilitating use of beneficial advertising opportunities for mitigating risks to a seller in connection with advertising costs, comprising:
receiving data that relates to an item for sale by a seller, the data including an indication of an expected net profit in connection with a sale of the item;
analyzing the data for determining an advertisement value represented by advertising the item for the seller;
updating the data based upon the act of analyzing; and
transmitting the updated data to a receiving component of an SEM system associated with a network-accessible search engine system.

18. The method of claim 17, further comprising at least one of the following acts:
determining the advertisement value further based upon a profit from the sale that exceeds the net profit expected by the seller;
determining the advertisement value further based upon examining a marketplace associated with the item;
examining ad space suitable for an advertisement for determining a cost per conversion;
determining a rank for the advertisement based upon the advertisement value;
choosing the advertisement from a set of advertisements based upon the rank; or
propagating the advertisement to the receiving component of the SEM system.

19. A method for mitigating risks to a seller in connection with advertising costs by subsuming the role of advertising for the seller, comprising:
negotiating an agreement for a SEM system to assume all costs associated with advertising an item for a seller of the item in exchange for a profit allocation to be paid by the seller to the SEM system after conversion of the item;
receiving an advertisement for the item;
selecting the advertisement from a set of advertisements based upon a rank of an advertisement value to the SEM system; and
transmitting the advertisement to an associated search engine system for display.

20. The method of claim 19, further comprising at least one of the following acts:
automatically generating the advertisement based upon information received from the seller;
ranking the advertisement in order to optimize potential profits to the SEM based upon the profit allocation;
assuming all costs associated with displaying the advertisement on the search engine system; or
receiving the profit allocation following a conversion of the item.
